(19) United States
(12) Patent Application Publication
(10) Pub. No.: US 2021/0125121 A1
(43) Pub. Date: Apr. 29, 2021

(54) MULTI-CHANNEL INTER-TEAM COMMUNICATION AND EVALUATION SYSTEM

(71) Applicant: Dark Matter Research, Inc. dba/ Kettle, San Francisco, CA (US)

(72) Inventors: Alexander CHIOCCHI, San Francisco, CA (US); Dan CHIAO, San Francisco, CA (US); Jim SMITLEY, Roscoe, IL (US); Hiroaki OYAIZU, Hoboken, NJ (US)

(21) Appl. No.: 17/079,481

(22) Filed: Oct. 25, 2020

Related U.S. Application Data
(60) Provisional application No. 62/926,151, filed on Oct. 25, 2019.

(51) Int. Cl. G06Q 10/06; H04L 12/58; H04L 29/06; H04L 29/08

(52) U.S. Cl. CPC G06Q 10/0639; H04L 67/10; H04L 65/403; H04L 51/12

(57) ABSTRACT

A multi-channel inter-team communication and evaluation system is disclosed. An example embodiment includes: a multi-channel inter-team communication and evaluation system comprising: a communication system user device having one or more light emitting elements, a physical center button providing a user input element, a system module including a data processor, a memory device, and a wireless communication component, a wireless charger, a battery element, and a clock element; the communication system user device being in network data communication with an inter-team communication server, the communication system user device and inter-team communication server being configured to assess communication information from a plurality of communication channels; assist with workplace productivity by managing workplace team communications, screening messages and phone calls for urgency and importance, encouraging good working and communication habits, escalating urgent communications, and logging non-urgent communications and providing automatic responses; and advise individuals and management in the workplace to achieve greater communication effectiveness.

### PRIORITY PATENT APPLICATION

This non-provisional patent application draws priority from U.S. provisional patent application Ser. No. 62/926,151; filed Oct. 25, 2019. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2018-2020, Dark Matter Research Inc., All Rights Reserved.

### TECHNICAL FIELD

This patent document pertains generally to communication networks, collaboration systems, communication escalation, and more particularly, but not by way of limitation, to a multi-channel inter-team communication and evaluation system.

### BACKGROUND

Common problems in conventional communications come from a lack of understanding of status and presence physically and digitally. Many communication and collaboration systems fail to create awareness of such presence and decrease the likelihood of contacts understanding relative communication urgency and when they will receive recognition of transmission of information.

### BRIEF DESCRIPTION OF THE DRAWINGS

The various embodiments are illustrated by way of example, and not by way of limitation, in the figures of the accompanying drawings in which:

FIG. 1 illustrates the main components of a communication system user device of an example embodiment as disclosed herein;

FIGS. 2 through 10 illustrate elements and the housing of the communication system user device of an example embodiment;

FIG. 11 illustrates the communication network system components of an example embodiment as disclosed herein;

FIGS. 12 and 13 are communication system flow diagrams of an example embodiment;

FIGS. 14 through 16 are sample mobile device screenshots showing a user interface of an example embodiment;

FIGS. 17 through 19 are process flow diagrams showing a multi-channel communication escalation system of an example embodiment that ensures the correct type of communications are being used for the relative urgency and importance of information transmissions;

FIG. 20 is a process flow diagram showing user interface system diagram of a multi-channel communication system of an example embodiment;

FIGS. 21 and 22 illustrate elements of the collective intelligence assessment process used as part of an example embodiment; and

FIG. 23 is a processing flow chart illustrating an example embodiment of a multi-channel inter-team communication and evaluation system.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A multi-channel inter-team communication and evaluation system is disclosed. In the various example embodiments disclosed herein, a system creates awareness of a contact's presence to increase the likelihood of contacts understanding relative communication urgency and when they will receive recognition of transmission of information. The various example embodiments create a workplace ambient intelligence that uses a combination of hardware (a communication system user device) and networked system services (a communication system cloud) to coach workers to achieve better productivity. The various example embodiments attain this goal by providing at least three user value propositions. The inter-team communication system of an example embodiment can: 1) assess communication information from all channels to optimize methods of individual work and teamwork. The supported communication information channels include, calendar, email, chat, Slack™ desktop computer, video conference, smartphone, and other communication channels; 2) assist with workplace productivity by communicating with users through natural language. This productivity assistance can include managing workplace team communications, screening messages and phone calls for urgency and importance, encouraging good working and communication habits, escalating urgent communications, and logging non-urgent communications and providing automatic responses; and 3) advise individuals and management in the workplace to achieve greater communication effectiveness. The advisement role of the inter-team communication system of an example embodiment includes providing individuals with data and content that will help them achieve greater efficiency in their jobs, and advising leaders on the best ways to organize their workforce for productivity and satisfaction. These features of the various example embodiments disclosed herein are described in more detail below in connection with the diagrams provided herewith.

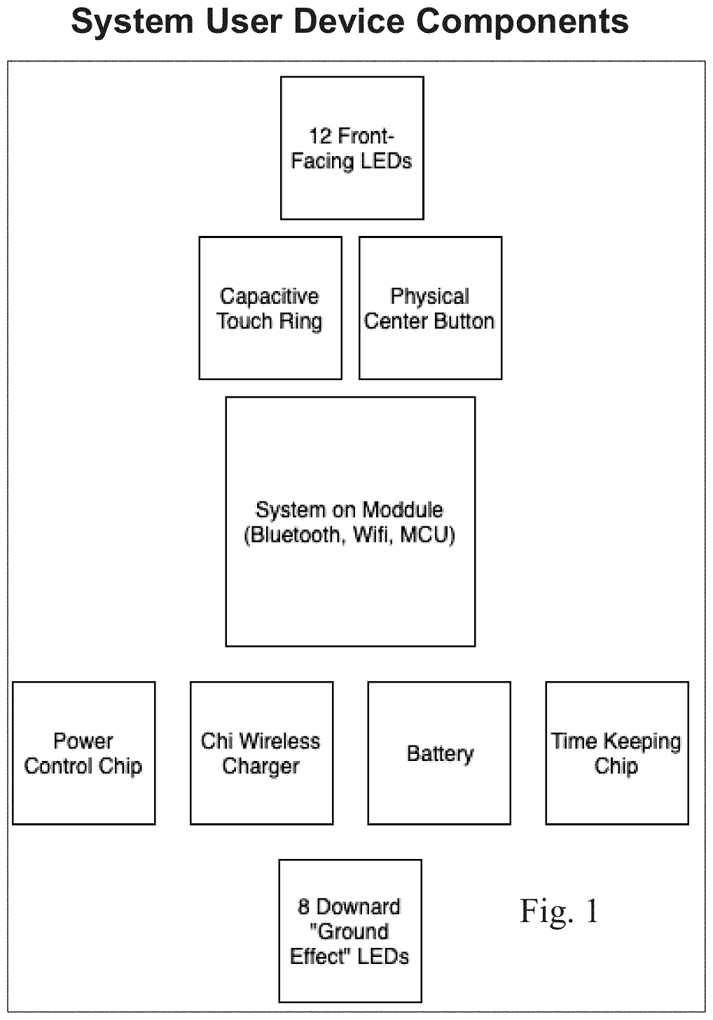

Referring now to FIG. 1, the diagram illustrates the main components of a communication system user device of an example embodiment as disclosed herein. The system user device can be a small and compact electronic device, which can be conveniently placed on a user's desktop or proximate to the user's work environment. The communication system user device of an example embodiment is a battery-powered, USB-rechargeable device that creates information parity or pairing between a smartphone, personal computer, enterprise communication services, and other workplace devices and services. As shown in FIG. 1, the system user device of an example embodiment can include front-facing or forward-facing LEDs or other light emitting elements, a capacitive touch ring or other user input element, a physical center button or other user input element, a system module including a data processor, a memory device, and a wireless communication component (e.g., Bluetooth™, WiFi, or the like), a power control chip, a wireless charger, a battery element, a time-keeping chip or clock element, and downward-facing LEDs or other light emitting elements. As described in more detail below, these system user device components of an example embodiment can be used to enable a user to better manage workplace communications and productivity.

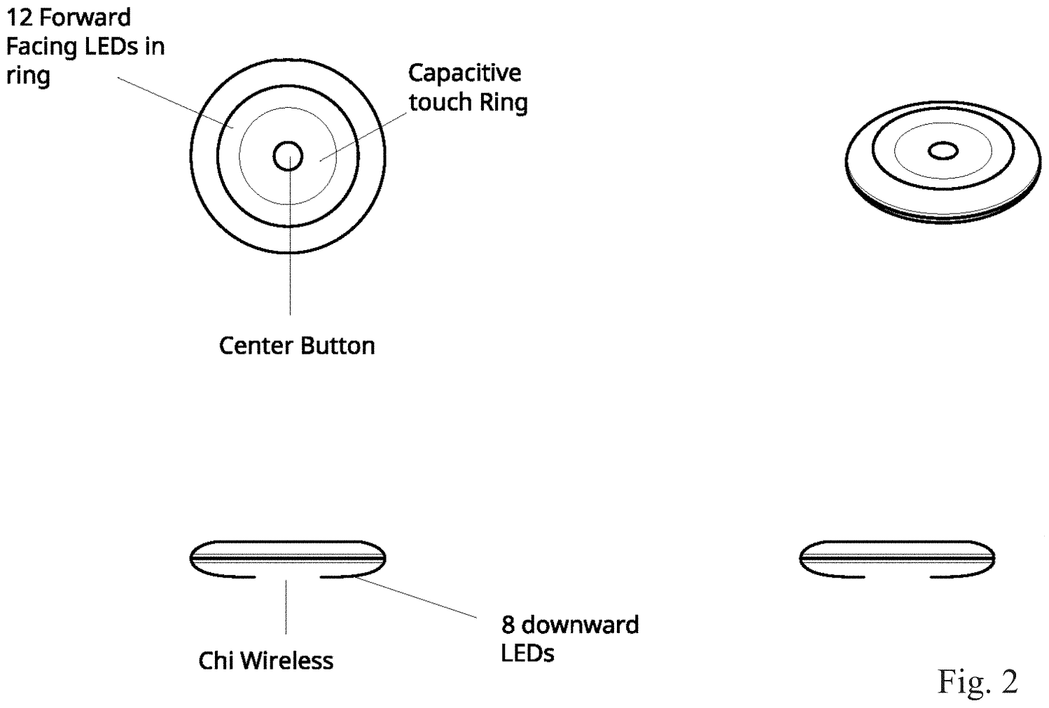

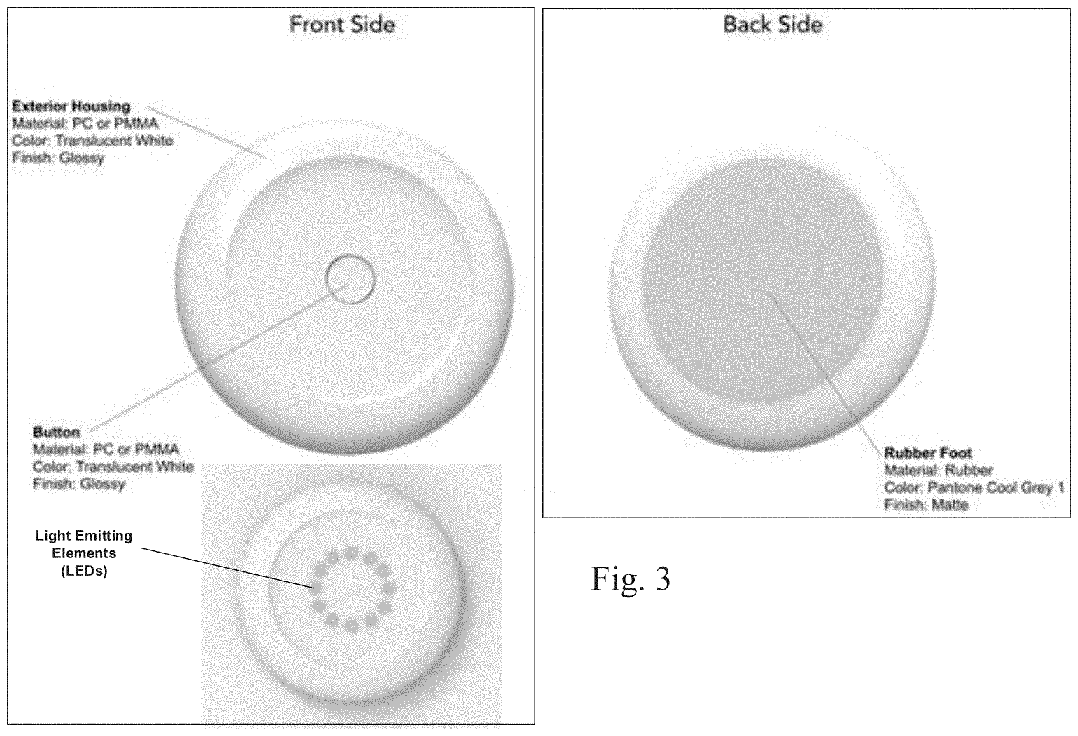

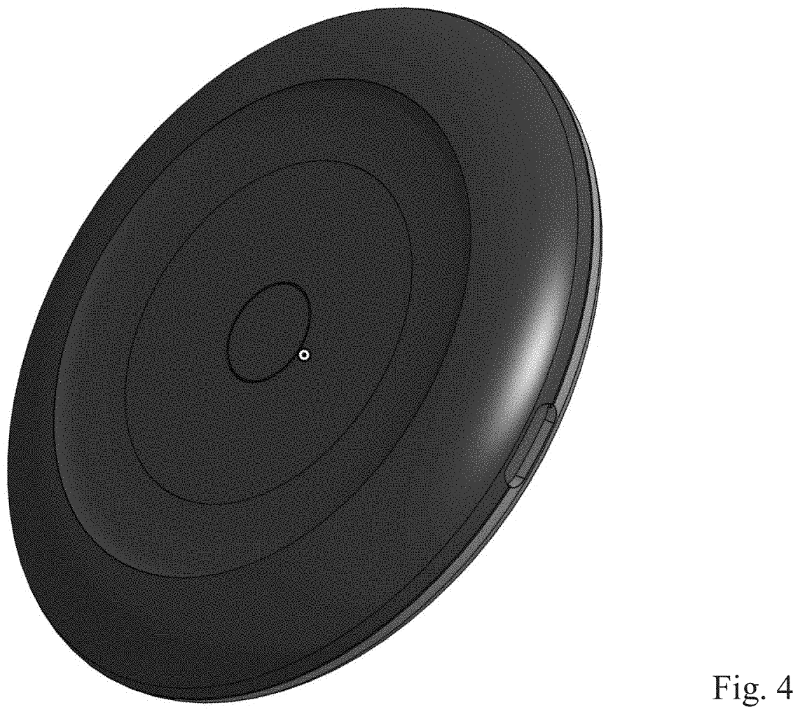

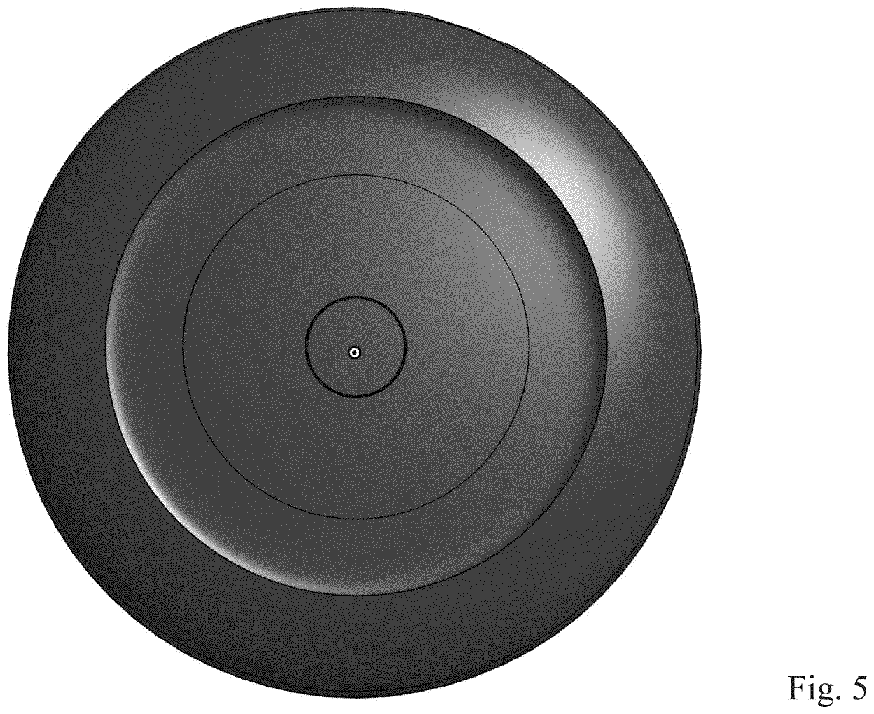

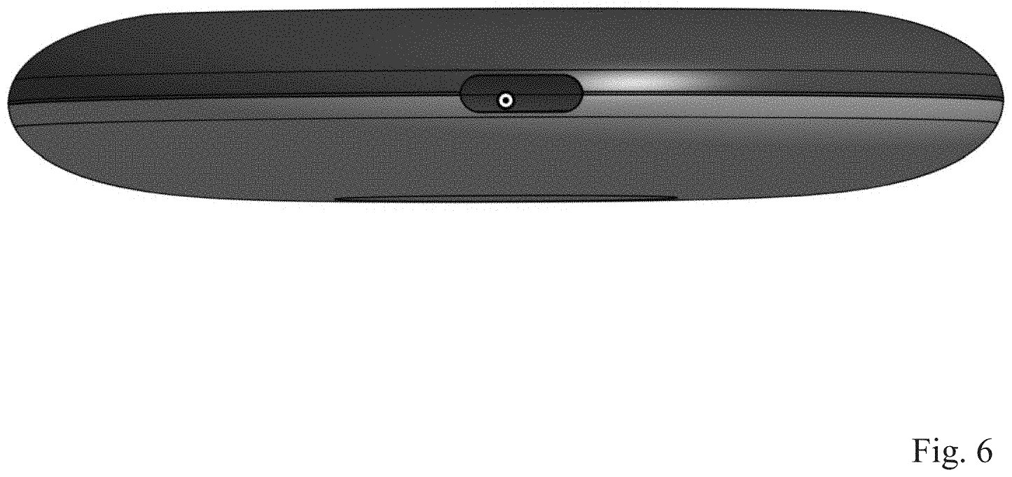

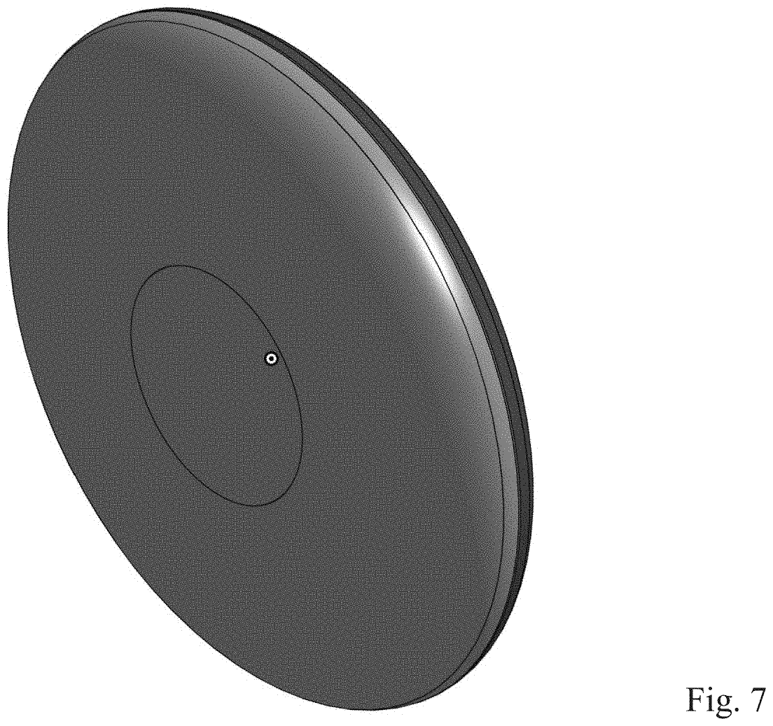

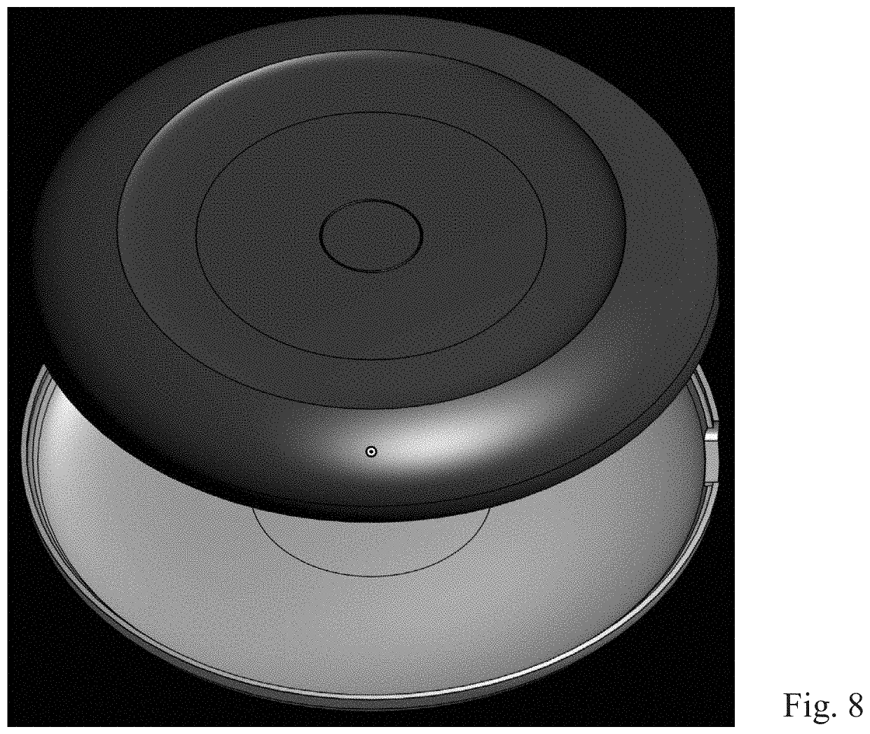

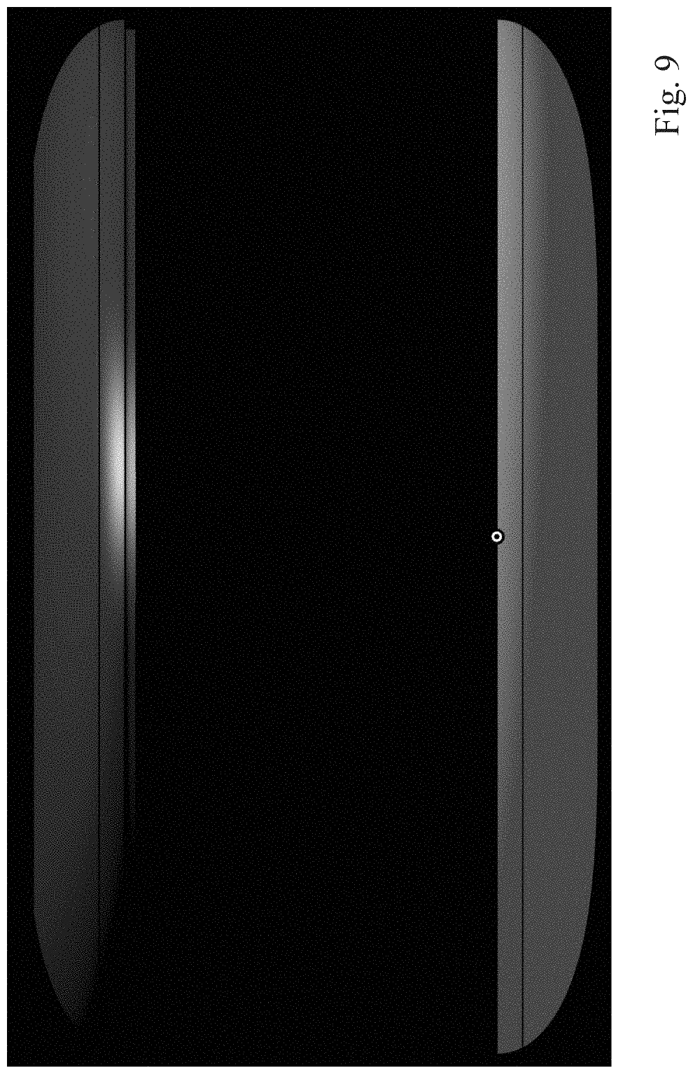

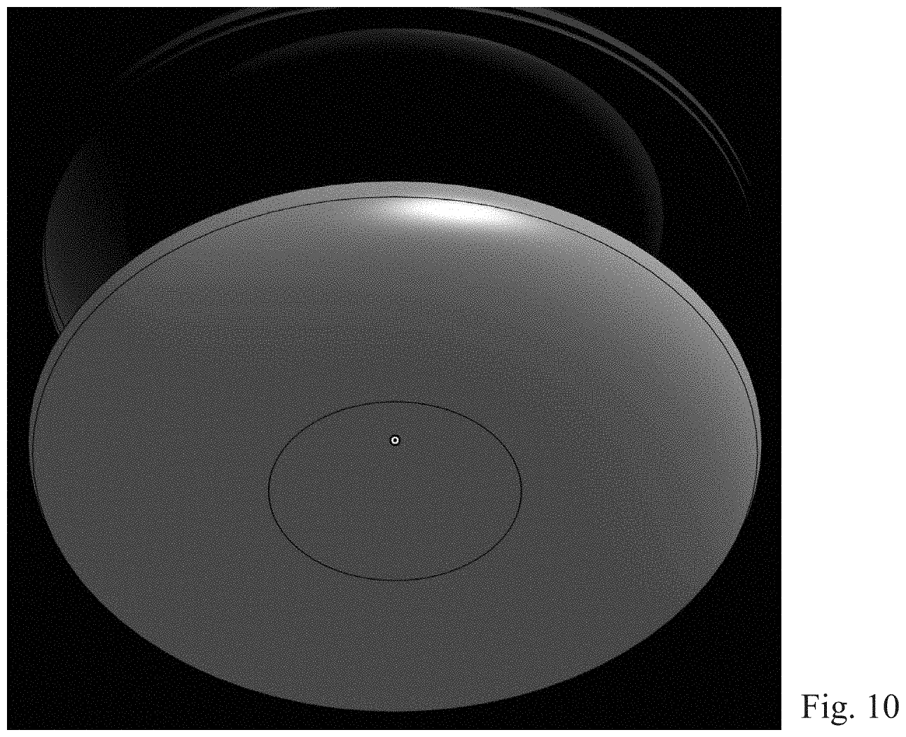

The system user device components of the example embodiment as described above can be retained within a system user device housing, such as the device housing illustrated in FIGS. 2 through 10. FIGS. 2 through 10 illustrate elements and the housing of the system user device of an example embodiment. As shown in FIG. 2, the system user device of the example embodiment can include the front-facing or forward-facing LEDs or other light emitting elements, the capacitive touch ring or other user input element, and the physical center button or other user input element. The system user device can also include the wireless communication component and the downward-facing LEDs or other light emitting elements within the user device housing. FIG. 3 illustrates the front and back sides of the user device housing showing the physical center button or other user input element. FIGS. 4 through 10 illustrate additional views of the user device housing of an example embodiment.

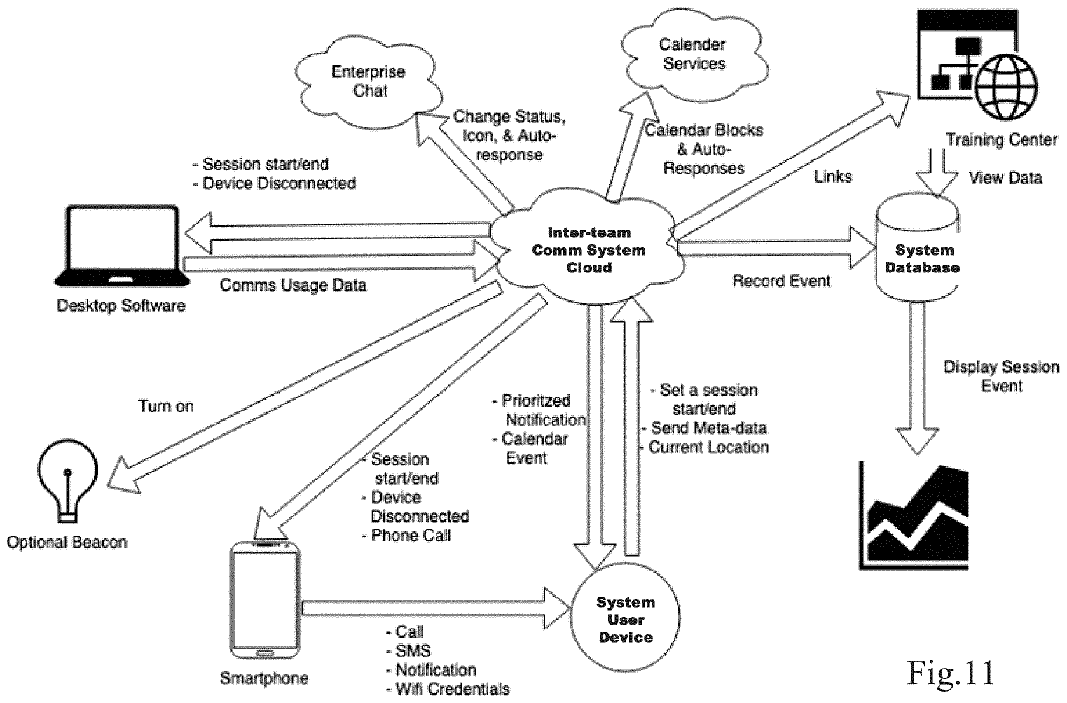

Referring now to FIG. 11, the diagram illustrates the network system components of an example embodiment as disclosed herein. In various example embodiments, a multi-channel inter-team communication system is provided to bridge communication across all channels, signal intent, and route communications to the right channels at the right times. In the disclosed embodiments, the communication system provides the system user device to serve as a data bridge or communication bridge between the user's computer, phone, and other user or workplace communication devices and services. The communication system of an example embodiment also provides a multi-channel signaling system of work intent and a multi-channel communication escalation system. These features of an example embodiment are described in more detail below.

### The Communication System User Device Provides a Communication Bridge

As described above, the communication system user device is a battery-powered, USB-rechargeable device that creates information parity between a smartphone, personal computer, and enterprise communication services regardless of make and model of either. The user device can be considered a “smart hub” for workplace communications. This communication bridge allows for a unique pairing of data that is not normally possible between, for example, Android™, personal computer (PC), MacOS™, iPhone™, and the user's cloud services. Systematic control over the flow of digital communications across all platforms is achieved through WiFi and Bluetooth™ wireless technology, among others. The communication system user device effectively serves as a channel router for semantic communications.

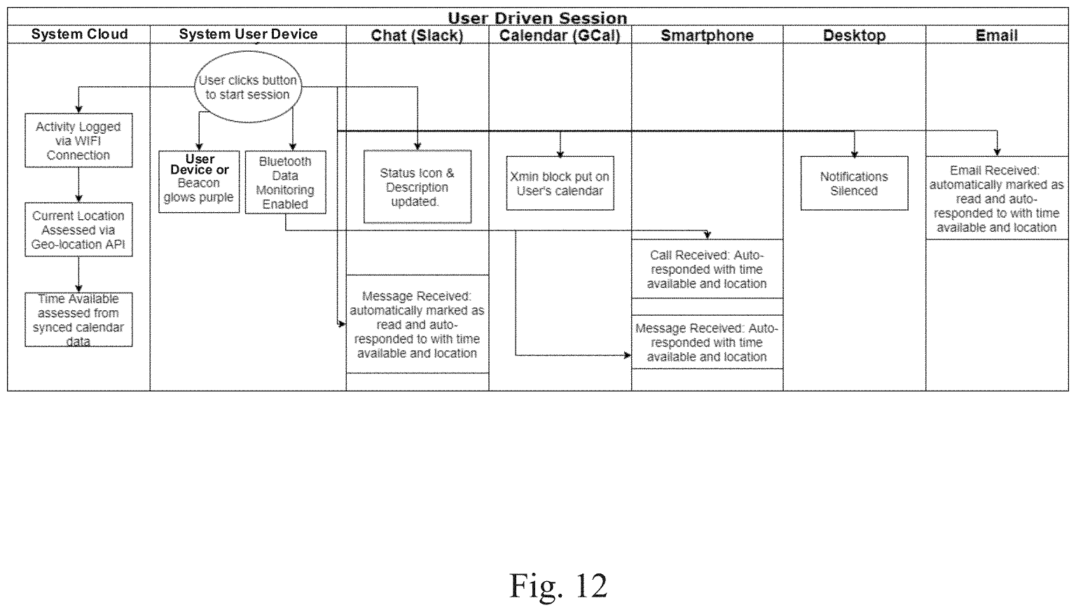

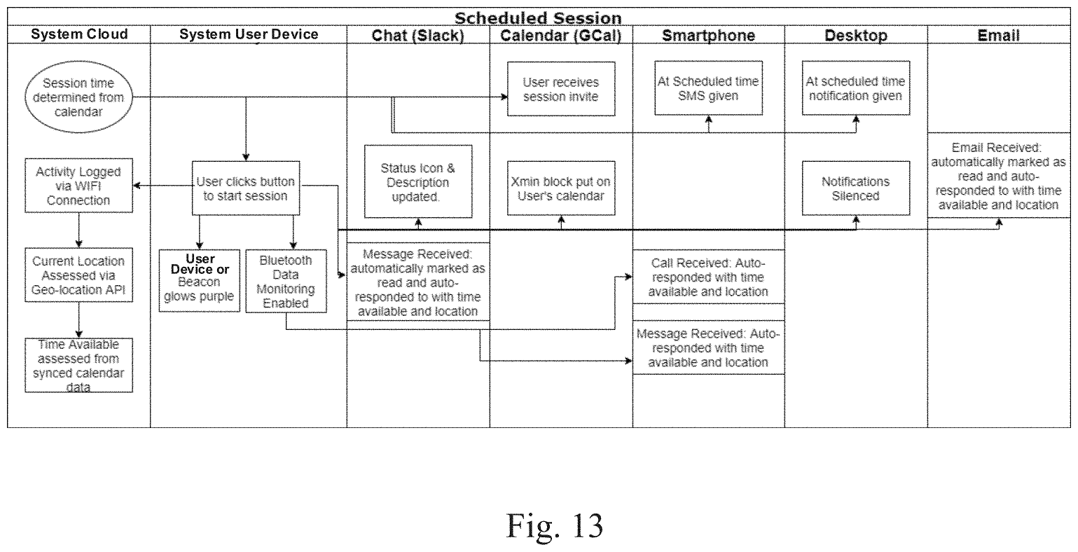

Referring again to FIG. 11, the communication system user device is shown in wireless network data communication with an inter-team communication system cloud server. The communication system user device is also shown in wireless network data communication with a user smartphone, for one example. The inter-team communication system cloud server can assess the communication flow between the user of system user device and various other communication channels including calendar services, email, enterprise chat, Slack™, desktop computer, video conference, smartphone, and other communication channels. As described in more detail below, the inter-team communication system cloud server can coordinate with the system user device to provide for the user productivity assistance including, screening messages and phone calls for urgency and importance, encouraging good working and communication habits, escalating urgent communications, and logging non-urgent communications and providing automatic responses. FIGS. 12 and 13 illustrate examples of communication flows for which the inter-team communication system of an example embodiment provides assistance.

FIGS. 12 and 13 are communication system flow diagrams of an example embodiment. As shown in FIG. 12, a user-driven communication session includes initial communications between the inter-team communication system cloud server and the communication system user device. Subsequently, the communications between the user and other communication channels (e.g., chat, Slack™, calendar services, smartphone, desktop computer, email services, etc.) can be effectively managed by the inter-team communication system of an example embodiment. As shown in FIG. 13, a schedule-driven communication session can include initial communications between the inter-team communication system cloud server and other communication channels (e.g., chat, Slack™, calendar services, smartphone, desktop computer, email services, etc.). The communication system cloud server can then communicate with the user via the system user device to determine the user's desired mode of communication at the moment.

### The Inter-Team Communication System Provides Multi-Channel Signaling of Work Intent

The inter-team communication system of an example embodiment provides a signaling system that works across all major channels of communications both physically and digitally. The communication system of an example embodiment provides at least two types of signals, 1) Status—the user is on a call, in a meeting, in deep focus, taking a wellness break, enjoying disconnect time, etc., and 2) Presence—the user is at his/her desk, working from home, working elsewhere, etc. When another party tries to contact the user via one of the communication channels described above, the inquiring contact is intercepted by the inter-team communication system of an example embodiment, which provides the inquiring contact with an automated response consistent with the context of the user being contacted. Alternatively or additionally, the inter-team communication system of an example embodiment can provides the inquiring contact with updates in among the following communication channels: calendar, instant messaging tools, SMS, phone call, and/or an indication in the user's physical workspace. Common issues in communications come from a lack of understanding of status and presence physically and digitally. The inter-team communication system of an example embodiment creates awareness of such presence to increase the likelihood of contacts understanding relative communication urgency and when they will receive recognition of transmission of information.

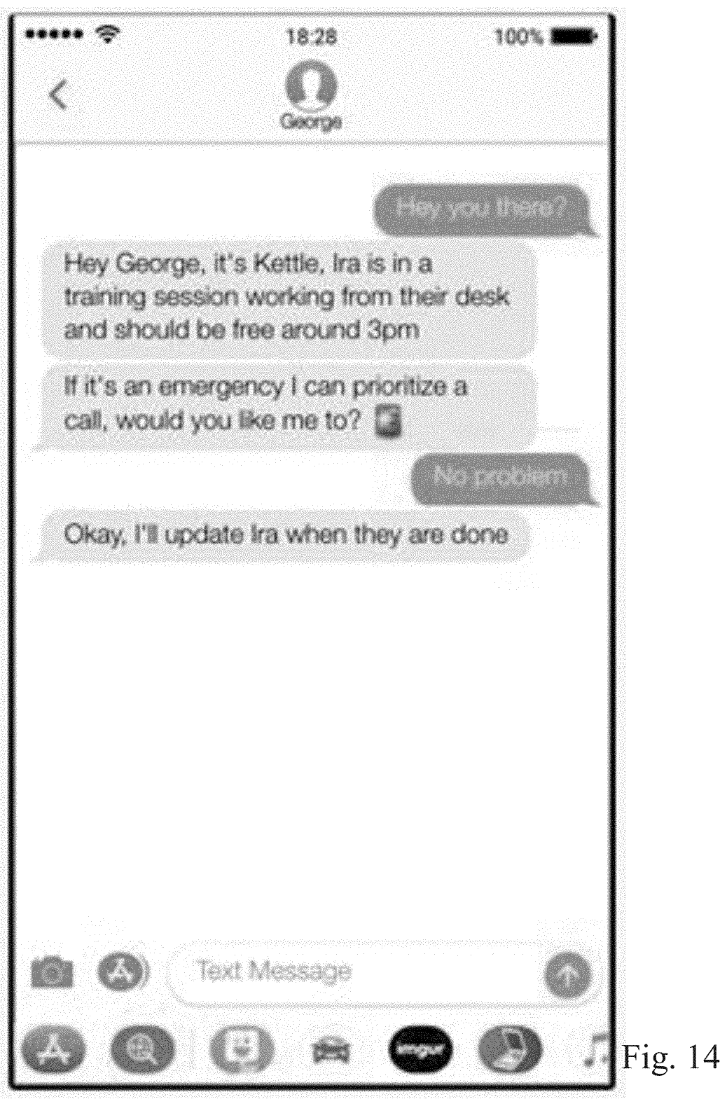

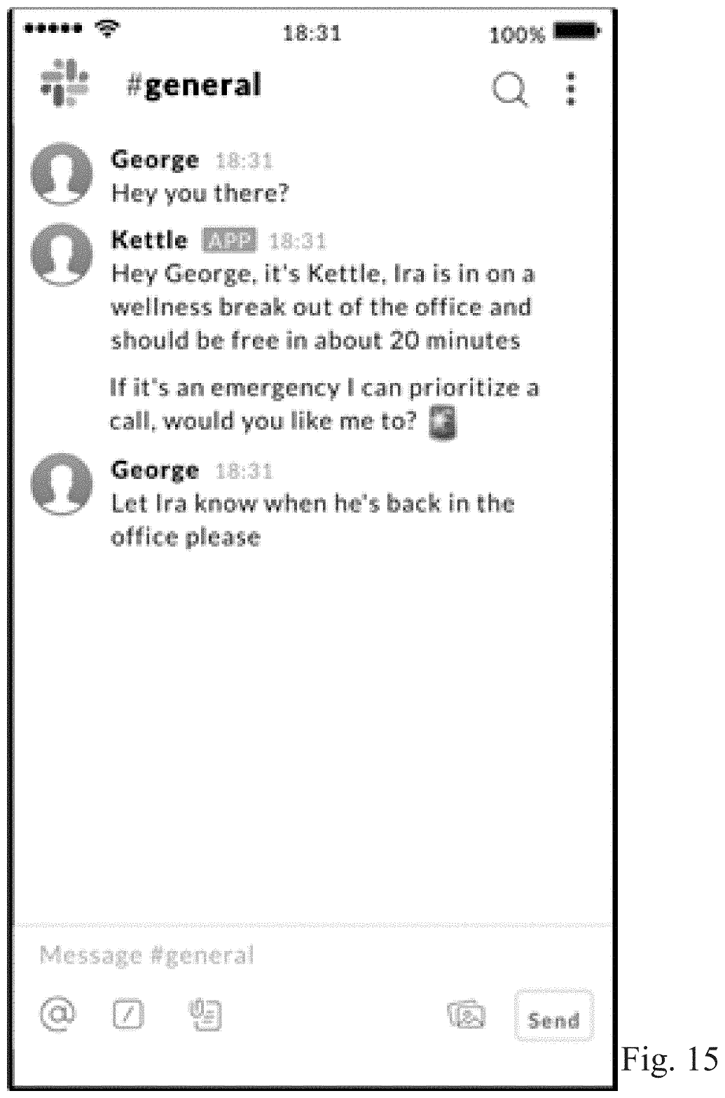

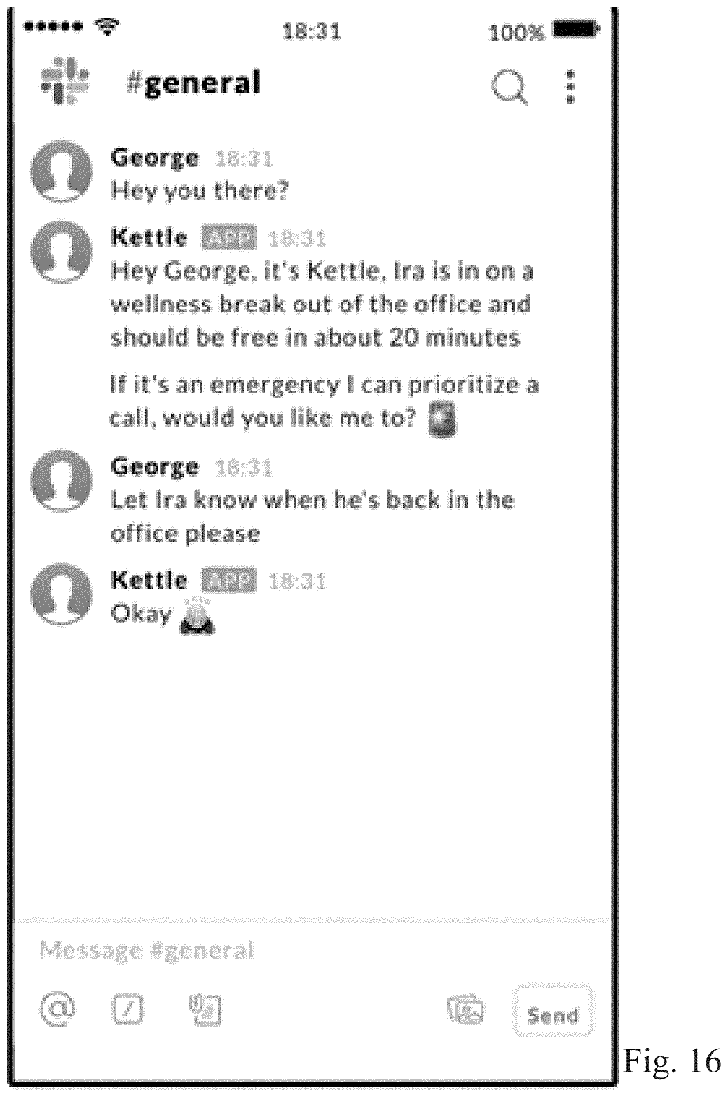

FIGS. 14 through 16 are sample mobile device screenshots showing a user interface of an example embodiment. As shown, the inter-team communication system cloud server and/or the system user device can message others attempting to communicate with the user via a mobile device to advise others of the communication mode currently desired by the user being contacted. In the examples shown, “Kettle” is a name given to the inter-team communication system of an example embodiment to personalize the communication to others on the user's behalf.

### The Inter-Team Communication System Provides Multi-Channel Communication Escalation

The inter-team communication system of an example embodiment provides multi-channel escalation that ensures the correct type of communications are being used for the relative urgency and importance of information transmission. Proper routing of communications ensures that a user receives the correct information at the correct time and decreases the likelihood of unnecessary distraction from activities based on the receipt of a new communication. In an example embodiment, the inter-team communication system includes escalation rules, predictive modeling, and user input to properly and efficiently receive, route, and dispatch newly received communications. In a particular embodiment, Guardian Urgency Analysis can be used as a rules engine. Additionally, a particular embodiment can use Google's™ Natural Language API to support the inter-team communication system.

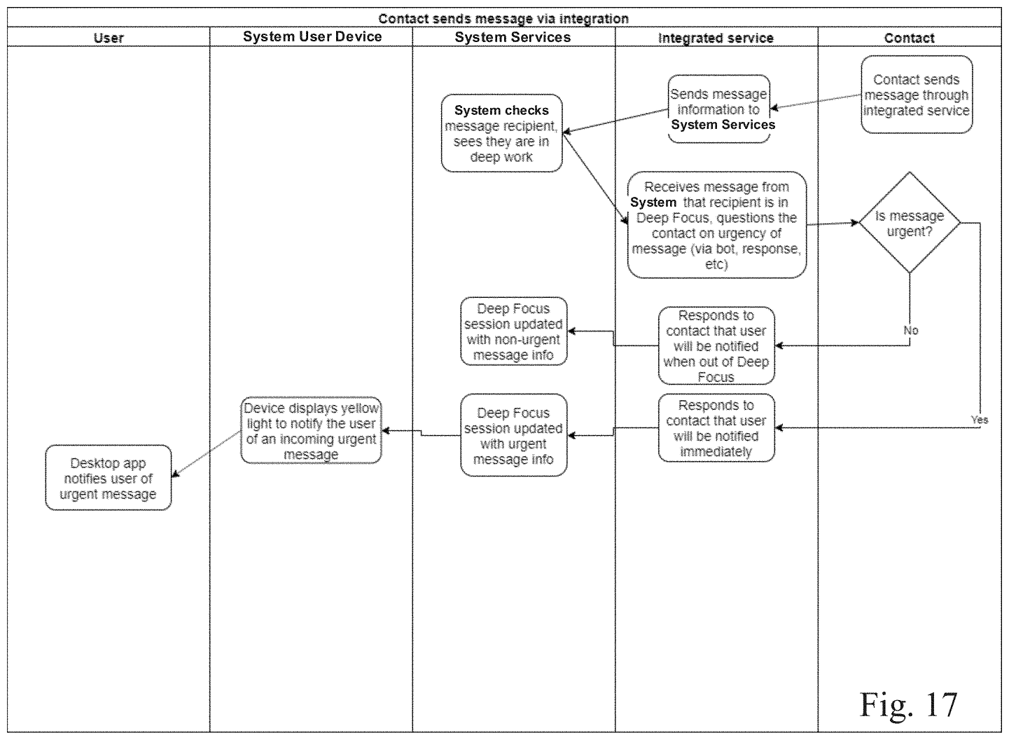

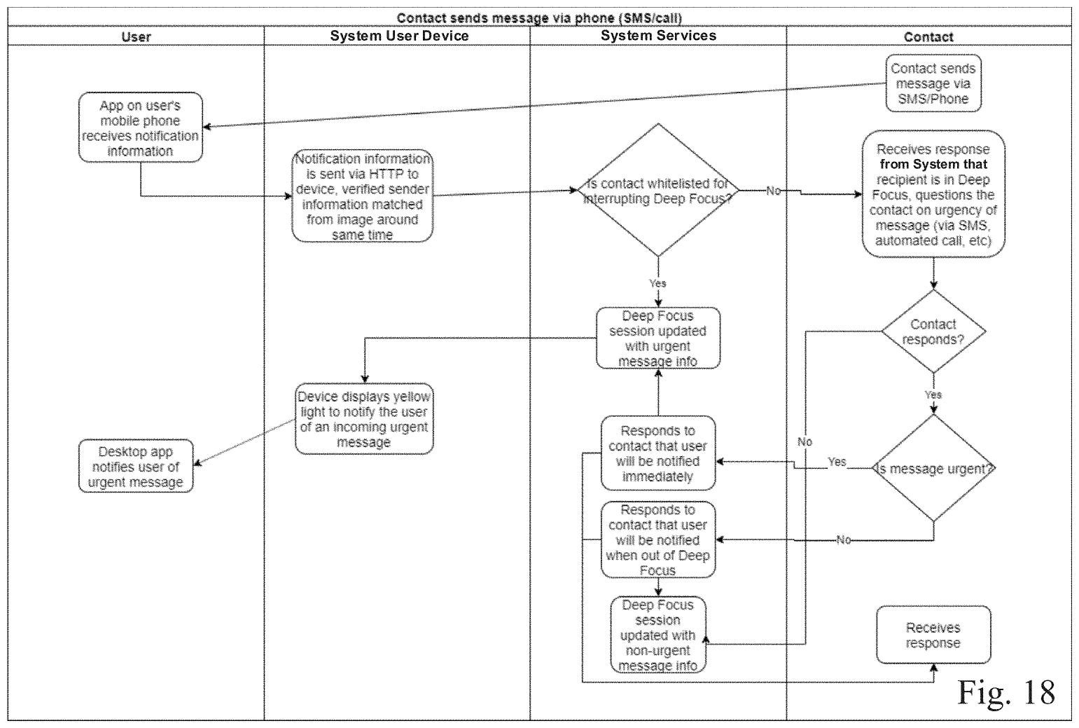

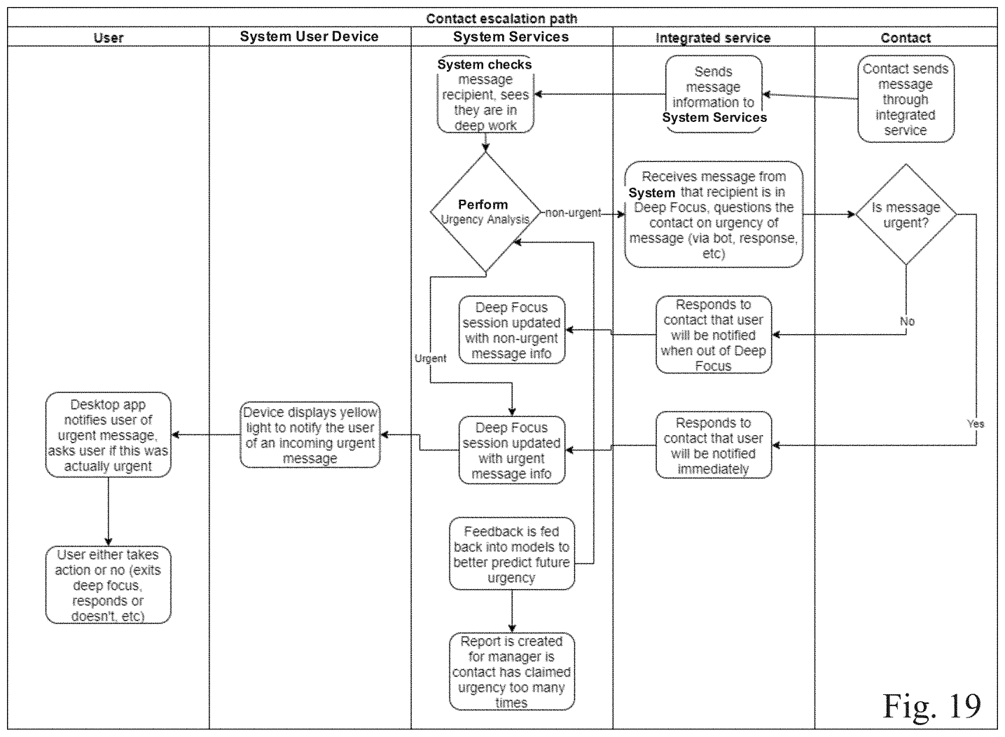

FIGS. 17 through 19 are process flow diagrams showing a multi-channel communication escalation system of an example embodiment that ensures the correct type of communications are being used for the relative urgency and importance of information transmissions. Referring to FIG. 17, an example process flow illustrates how the multi-channel communication escalation system of an example embodiment handles the receipt of a new message from an integrated service of a workplace. As shown, the system services supported by the inter-team communication system of an example embodiment receive the message from the integrated service and properly handle the message based on the current context of the user. FIG. 18 illustrates an example process flow showing how the multi-channel communication escalation system of an example embodiment handles the receipt of a new SMS message or call to a user's phone. Again, the system services supported by the inter-team communication system of an example embodiment receive the SMS message or call on the user's phone and properly handle the message or call based on the current context of the user. FIG. 19 illustrates an example process flow showing how the multi-channel communication escalation system of an example embodiment handles communication escalation. Note that the inter-team communication system assesses the urgency of an incoming communication and properly dispatches the communication based on the urgency assessment and the context of the user to whom the incoming communication was directed.

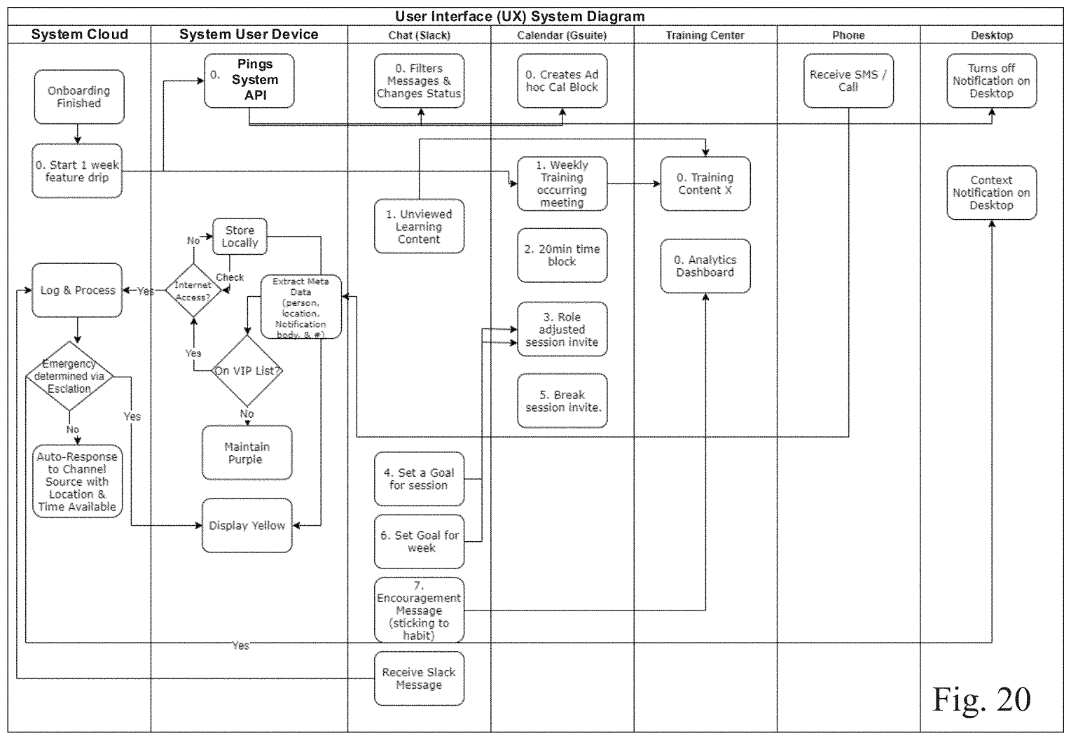

FIG. 20 is a process flow diagram showing user interface system diagram of a multi-channel communication system of an example embodiment.

The Inter-Team Communication System Provides a Method for Evaluating Collective Intelligence and Team Performance Risk from Communications

The inter-team communication system of an example embodiment provides a monitoring and prediction system for predicting workplace teams that are performing well or poorly based on passive inference from communication systems. In an example embodiment, the inter-team communication system monitors communications to/from team members and generates scoring values representing the communication and workplace efficiencies corresponding to the team's communications. In the example embodiment, scoring outputs can include six variables with scores ranging from 0-100 for each. These scoring metrics are described in more detail below. A score of zero (0) represents the lowest score and 100 represents the highest score as measures or metrics for the collective intelligence of the team being monitored. Higher scores are associated with the desired team behaviors and thus indicate high team performance.

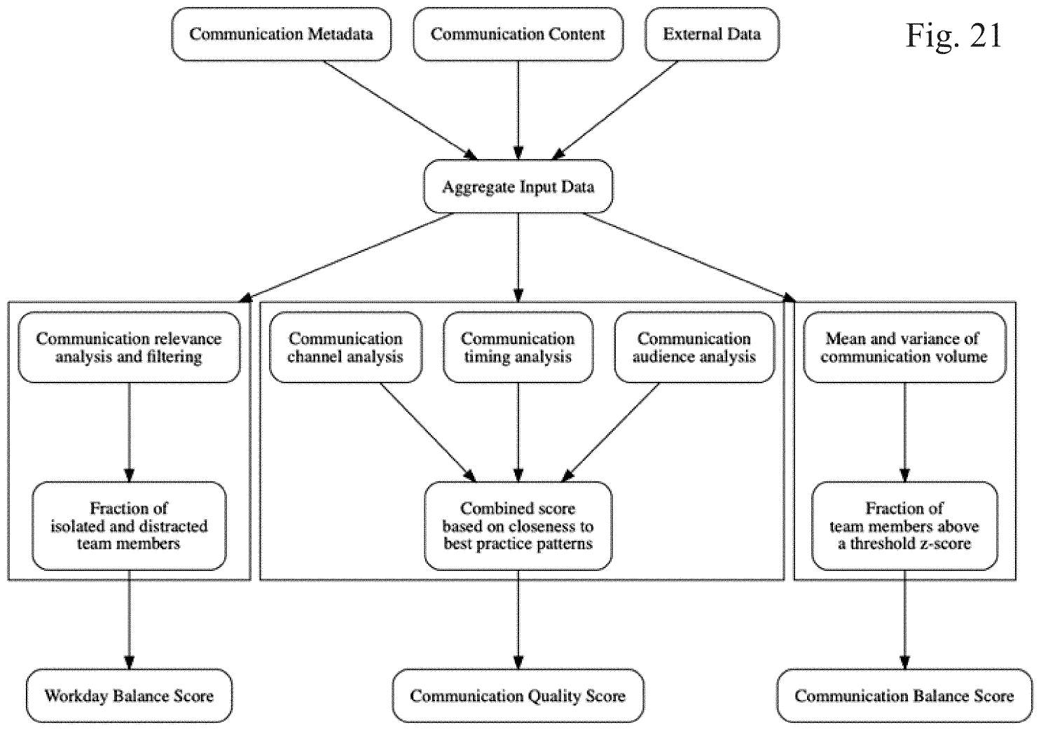

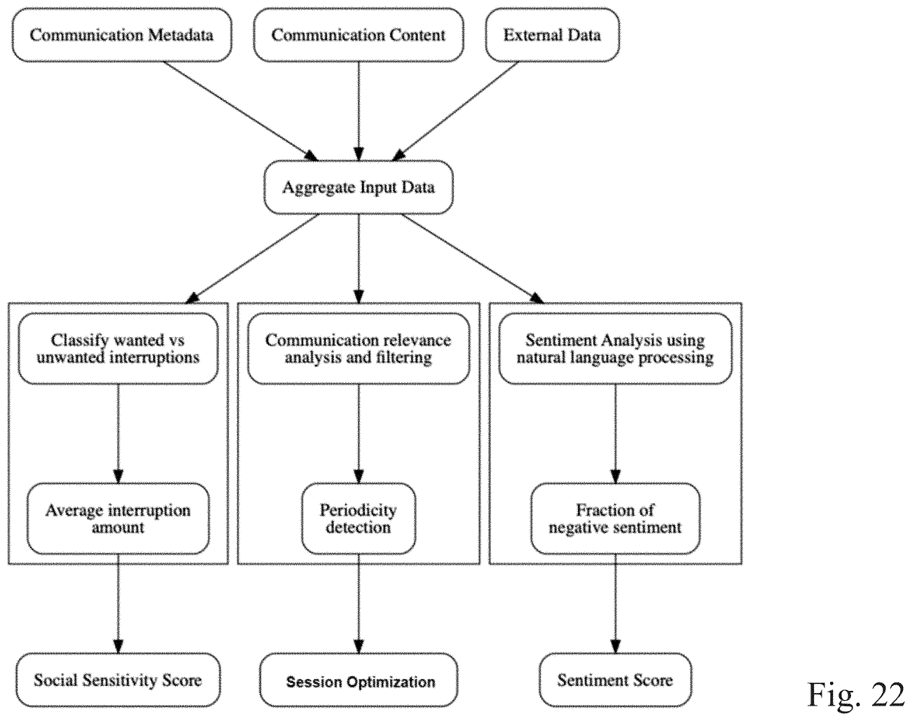

FIGS. 21 and 22 illustrate elements of the collective intelligence assessment process used as part of an example embodiment. In a particular embodiment of the inter-team communication system as shown in FIGS. 21 and 22, there are three types of input data used to generate the workplace team metrics. Firstly, the inter-team communication system can use the communications received or sent by the members of the team being monitored. These team communications, complete with communication content (Communication Content), are fully accessible for analysis by the inter-team communication system as described above. Secondly, the inter-team communication system can use the communication metadata (Communication Metadata), which can include information such as the time of the communication, the intended audience, the media used, the status of the communication, and other information related to particular communications. Metadata can be used by the inter-team communication system in situations where the team is unwilling to share the actual communication content because of its sensitive nature. Thirdly, the inter-team communication system can use additional, non-communication data (External Data) given by the team or its leader, such as the team's organizational chart, team members' roles, a list of other teams with which it collaborates, and the like. As shown in FIGS. 21 and 22, these three types of input data used to generate the workplace team metrics can be aggregated to create a combined set of input data. As also shown in FIGS. 21 and 22, this combined set of input data can be processed by the inter-team communication system of an example embodiment to generate six scoring values representing the communication and workplace efficiencies and predictive team performance corresponding to the monitored team's communications. These six scoring values representing a team's collective intelligence can include: workday balance, communication balance, communication quality, social sensitivity, individual session optimization, and sentiment. Each of these team collective intelligence scoring values are described in detail below.

### 1. Workday Balance

This scoring metric represents the proportion of a team that is isolated or that never has time for focused work (distracted).

### A. Definitions

a. Focused work is defined as a period of time without contact from the rest of the team.
b. An individual is defined as isolated if a large portion of the individual's work days are spent in focused work.
c. An individual is defined as distracted if the individual spends a small fraction of the individual's work days in focused work.

### B. Methodology—Metadata Only

a. Data used: metadata from the team's calendar and messaging communications, such as timestamps of events and communications, the type and target of the communications, and etc.
b. The inter-team communication system can measure the fraction of users within a team that are isolated or distracted according to the definitions.

### C. Methodology—Full Data

a. Data used: metadata and the content of the team's calendar and messaging communications, including the content of the team member's communications and the descriptions of the events on the members' calendars.
b. Using the messaging and calendar contents, we filter out spurious and irrelevant communications and events. These filtered entries may include general announcements, calendar events mistakenly made, and other entries deemed inconsequential.
c. The inter-team communication system can measure the fraction of users within a team that are isolated or distracted according to the definitions.

### D. Methodology—Parameter Calibration

a. Sentiment

### 2. Communication Balance

This scoring metric represents the proportion of a team that are noise makers or reticent.

### A. Definition

a. A noise maker is defined as someone that creates communication volume significantly more than an average team member, measured by the number of standard deviations away from mean volume.
b. A reticent member is defined as someone that creates communication volume significantly less than an average team member.
c. Communication Volume is a combination of the amount of the following qualities:
   i. Communication frequency
   ii. Single communication density—Density of content within a communication (length, use of superlatives, relevance to work, etc.)

### B. Methodology—Metadata Only

a. Data used: metadata of communication sent by team members (timestamp, intended target, etc.)
b. The inter-team communication system can compute the mean volume and its variance of the team's communications, based solely on the frequency of the communication.
c. For each team member, the inter-team communication system can compute their communication volume, and compute their z-score.
d. The inter-team communication system can compute the number of members above a threshold z-score.

### C. Methodology—Full Data

a. Same as for metadata-only method, except that we consider communication density as well as communication frequency when computing the communication volume.
b. Identify work context. Training on large data sets of communication.
   i. Watercooler chat (Slack groups)
   ii. Engineering related chat
   iii. Business emails

### D. Methodology—Parameter Calibration

a. The z-score threshold will be continuously updated to maximize the efficacy of the score, based on feedback from users.
b. Feedback Based from Customer

### 3. Communication Quality

This scoring metric represents the measure of communication effectiveness, efficiency, and comfort. The inter-team communication system can classify and quantify communications to score how well the communications are reaching the right people, at the right time, in the right way.

### A. Definitions

a. Right People—Communications should be reaching the members of the team that need the information but no one else. Whether a member needs the information is determined by organization charts, the group to which the member belongs, and through analysis of the content of the communication.
   i. Input: HRIT Organization Hierarchy
   ii. Input: Leader input
b. Right Time—Communications should have a rhythm that optimizes productivity while minimizing disruption. For example, communications for planning should happen early in the project development cycle, and communications for status updates should happen in sync with the cadence of the team.
   i. Input: Leader input regarding team's development cadence
c. Right Way—Communications should be channeled via media appropriate for their purposes and efficiencies by author.
   i. Input: Usage data for various communication media supported by the inter-team communication system.
      a. Email
      b. Slack
      c. SMS/Chat
      d. Call
      e. Meeting
   ii. Understand the nature of the communication from an author
      a. Email, one-way announcement
         i. Recipients
         ii. Continued Conversation
      b. Slack, status check-in
         i. Recipients
         ii. Content of message for “emergency” or “work” terms
         iii. Length of continued conversation
      c. SMS, time-sensitive status check-in
         i. Recipients
         ii. Content of message for “emergency” or “work” terms
      d. Call, emergency
         i. Recipients
         ii. Content of message for “emergency” or “work” terms
      e. Meeting, for brainstorm
         i. Looking at recipients
         ii. Physical Proximity
         iii. Attendees in the Conference tool

### B. Methodology—Metadata Only

a. The inter-team communication system can measure the efficiency of user communication across various channels by counting the frequency of communications and assigning weights based on the amount of effort a channel takes. For example, a chat communication takes little effort and is weighted low, while phone calls take more effort and are weighted highly. For this scoring, the inter-team communication system can consider meetings to be a form of communication with high weight due to their disruptive nature.
b. The inter-team communication system can determine the baseline total cost that a well-run team should have (given team size, composition, etc.). The baseline can be computed from team surveys and academic research, and can be continuously updated.
c. The score is based on the deviation from this baseline (e.g., 0 represents a state of being perfectly in-line with the baseline, 100 represents a state of being maximally divergent from the baseline).

### C. Methodology—Full Data

a. In addition to the above, the inter-team communication system can analyze the content of the communications and weight them further.
b. The inter-team communication system can also analyze the content for sentiment, looking for signs of tension, conflict, inappropriate or offensive communications, and negative reactions. The inter-team communication system can combine the frequency of such sentiments into the overall communication quality score. Ultimately, the inter-team communication system can identify business or engineering related language with signs of frustration to determine if a message is urgent or not.

### 4. Social Sensitivity

This scoring metric represents unwanted disruption frequency.

### A. Definitions

a. Unwanted disruption is any communication received while in focused work.

### B. Methodology—Metadata Only

a. The inter-team communication system can count the number of interruptions detected during a user's session time, tabulating the total count and the total amount of time being interrupted.
b. The inter-team communication system can then compute the fraction of the advertised focused work time during which the users are being interrupted.

### C. Methodology—Full Data

a. Same as the case for metadata-only method, except that the inter-team communication system can filter and weight interruptions according to how disruptive they are, weighing easy to ignore interruptions less (certain chat communications) and hard to ignore interruptions more (phone calls).

### 5. Individual Session Optimization

This scoring metric represents the proportion of the team's work done as part of regularly scheduled sets of workloads suitable for each member's work style.

### A. Definitions

a. Regularly scheduled events are a set of events of similar nature (e.g., type, timing, duration, etc.) scheduled with some regularity (e.g., repeated daily, weekly, or monthly, etc.).

### B. Methodology—Metadata Only

a. The inter-team communication system can look for patterns in the calendar events timing and communication frequencies at different times of day, using techniques such as Fourier analysis, beat detection, etc.

### C. Methodology—Full Data

a. Similar to the metadata-only method, but the calendar events and communications are weighted by their significance before being analyzed.

### 6. Sentiment

This scoring metric represents the measure of team members' perception of their ability to get work done in their current environment.

### A. Methodology—Metadata Only

a. The inter-team communication system can periodically query the team members, typically after a user session, about their sentiment of the work environment in a micro-survey format. The results of these surveys are analyzed for repeated or prolonged signs of frustration.

### B. Methodology—Full Data

a. The inter-team communication system can analyze the sentiment of communication amongst teammates using a natural language processing pipeline, specifically looking for signs of repeated frustration.

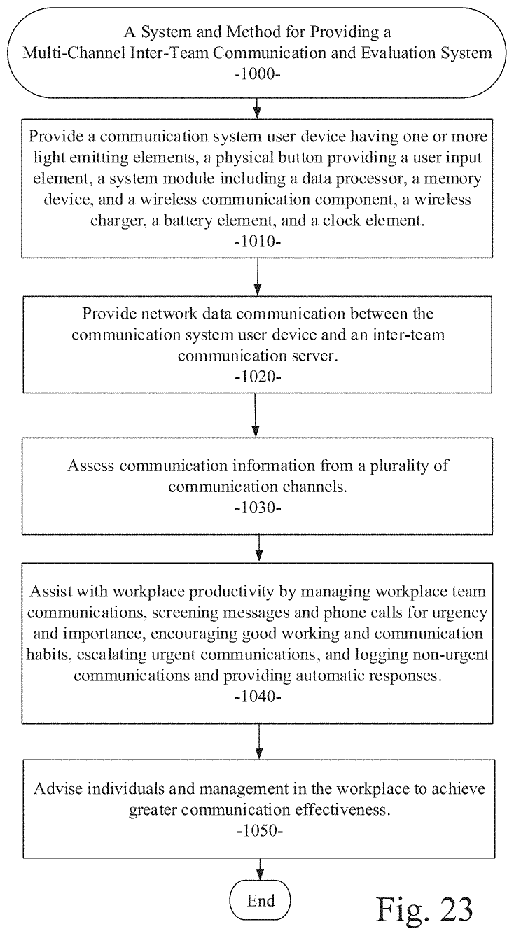

FIG. 23 is a processing flow diagram illustrating an example embodiment of the multi-channel inter-team communication and evaluation system as described herein. The method 1000 of an example embodiment including: providing a communication system user device having one or more light emitting elements, a physical button providing a user input element, a system module including a data processor, a memory device, and a wireless communication component, a wireless charger, a battery element, and a clock element (processing block 1010); providing network data communication between the communication system user device and an inter-team communication server (processing block 1020); assessing communication information from a plurality of communication channels (processing block 1030); assisting with workplace productivity by managing workplace team communications, screening messages and phone calls for urgency and importance, encouraging good working and communication habits, escalating urgent communications, and logging non-urgent communications and providing automatic responses (processing block 1040); and advising individuals and management in the workplace to achieve greater communication effectiveness (processing block 1050).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A multi-channel inter-team communication and evaluation system comprising:
a communication system user device having one or more light emitting elements, a physical button providing a user input element, a system module including a data processor, a memory device, and a wireless communication component, a wireless charger, a battery element, and a clock element; the communication system user device being in network data communication with an inter-team communication server, the communication system user device and inter-team communication server being configured to assess communication information from a plurality of communication channels; assist with workplace productivity by managing workplace team communications, screening messages and phone calls for urgency and importance, encouraging good working and communication habits, escalating urgent communications, and logging non-urgent communications and providing automatic responses; and advise individuals and management in the workplace to achieve greater communication effectiveness.

2. The multi-channel inter-team communication and evaluation system of claim 1 wherein the plurality of communication channels includes a communication channel with a mobile phone and a communication channel with a system database.

3. The multi-channel inter-team communication and evaluation system of claim 1 wherein the plurality of communication channels includes a communication channel with a personal computer (PC) and a communication channel with an enterprise cloud service.

4. The multi-channel inter-team communication and evaluation system of claim 3 wherein the enterprise cloud service is an enterprise chat service, Slack™, an email service, or a calendar service.

5. The multi-channel inter-team communication and evaluation system of claim 1 being configured to provide at least two types of signals: 1) Status, corresponding to a signal indicating that a user is currently on a call, in a meeting, in deep focus, taking a wellness break, or enjoying disconnect time, and 2) Presence, corresponding to a signal indicating that the user is at a desk, working from home, or working elsewhere.

6. The multi-channel inter-team communication and evaluation system of claim 1 wherein the inter-team communication server being configured to intercept a communication from an inquiring contact and provide the inquiring contact with an automated response consistent with a context of a user being contacted.

7. The multi-channel inter-team communication and evaluation system of claim 1 wherein the inter-team communication server being configured to intercept a communication from an inquiring contact and provide the inquiring contact with an update using a communication channel from a group consisting of: a calendar, an instant messaging tool, SMS, a phone call, and an indication in a physical workspace of a user being contacted.

8. The multi-channel inter-team communication and evaluation system of claim 1 being configured to escalate a communication from an inquiring contact based on a relative urgency and importance of the communication and consistency with a context of a user being contacted.

9. The multi-channel inter-team communication and evaluation system of claim 1 being configured to monitor communications between team members and generate scoring values representing communication and workplace efficiencies corresponding to the team's communications.

10. The multi-channel inter-team communication and evaluation system of claim 9 wherein the scoring values are based on communication content, communication metadata, and external data.

11. The multi-channel inter-team communication and evaluation system of claim 1 being configured to generate workplace team scoring values representing workday balance, communication balance, communication quality, social sensitivity, individual session optimization, and sentiment.

12. A method for multi-channel inter-team communication and evaluation, the method comprising:
providing a communication system user device having one or more light emitting elements, a physical button providing a user input element, a system module including a data processor, a memory device, and a wireless communication component, a wireless charger, a battery element, and a clock element;
providing network data communication between the communication system user device and an inter-team communication server;
assessing communication information from a plurality of communication channels;
assisting with workplace productivity by managing workplace team communications, screening messages and phone calls for urgency and importance, encouraging good working and communication habits, escalating urgent communications, and logging non-urgent communications and providing automatic responses; and
advising individuals and management in the workplace to achieve greater communication effectiveness.

13. The method of claim 12 wherein the plurality of communication channels includes a communication channel with a mobile phone and a communication channel with a system database.

14. The method of claim 12 wherein the plurality of communication channels includes a communication channel with a personal computer (PC) and a communication channel with an enterprise cloud service.

15. The method of claim 12 including providing at least two types of signals: 1) Status, corresponding to a signal indicating that a user is currently on a call, in a meeting, in deep focus, taking a wellness break, or enjoying disconnect time, and 2) Presence, corresponding to a signal indicating that the user is at a desk, working from home, or working elsewhere.

16. The method of claim 12 including intercepting a communication from an inquiring contact and providing the inquiring contact with an automated response consistent with a context of a user being contacted.

17. The method of claim 12 including intercepting a communication from an inquiring contact and providing the inquiring contact with an update using a communication channel from a group consisting of: a calendar, an instant messaging tool, SMS, a phone call, and an indication in a physical workspace of a user being contacted.

18. The method of claim 12 including escalating a communication from an inquiring contact based on a relative urgency and importance of the communication and consistency with a context of a user being contacted.

19. The method of claim 12 including monitoring communications between team members and generating scoring values representing communication and workplace efficiencies corresponding to the team's communications.

20. The method of claim 12 including generating workplace team scoring values representing workday balance, communication balance, communication quality, social sensitivity, individual session optimization, and sentiment.
